(19) United States
(12) Patent Application Publication
(10) Pub. No.: US 2026/0116197 A1
(43) Pub. Date: Apr. 30, 2026

(54) VEHICLE BATTERY PROTECTION DEVICE

(71) Applicant: TOYOTA JIDOSHA KABUSHIKI KAISHA, Toyota-shi (JP)

(72) Inventor: Seiya ISHIKURA, Toyota-shi (JP)

(73) Assignee: TOYOTA JIDOSHA KABUSHIKI KAISHA, Toyota-shi (JP)

(21) Appl. No.: 19/312,761

(22) Filed: Aug. 28, 2025

(30) Foreign Application Priority Data
Oct. 30, 2024 (JP) 2024-191138

(51) Int. Cl. B60L 3/00; B60K 1/04; B60K 28/10; B60K 31/00

(52) U.S. Cl. CPC B60L 3/0007; B60K 28/10; B60K 31/0008; B60K 2001/0438

(57) ABSTRACT

A battery protection device includes a flap provided at a lower portion of a vehicle body of a vehicle in which a battery is disposed below the floor of the vehicle body. The flap is movable between a deployed position in which the flap protrudes from the lower surface of the vehicle body, and a retracted position in which the flap is retracted upward from the deployed position. A LiDAR or a camera detects an obstacle located in the direction of travel of the vehicle. When a control unit determines that there is a possibility that the obstacle detected by the LiDAR or the camera may come into contact with the battery, the control unit moves the flap to the deployed position.

### CROSS-REFERENCE TO RELATED APPLICATION

This application claims priority to Japanese Patent Application No. 2024-191138 filed on Oct. 30, 2024. The disclosure of the above-identified application, including the specification, drawings, and claims, is incorporated by reference herein in its entirety.

### BACKGROUND

### 1. Technical Field

The present disclosure relates to vehicle battery protection devices.

### 2. Description of Related Art

Japanese Unexamined Patent Application Publication No. 2022-70848 (JP 2022-70848 A) discloses a battery protection member in which an inclined surface and a buffer chamber are formed. When an obstacle collides with the inclined surface, the battery protection member undergoes rearward deflection and deformation, and at the same time, the buffer chamber absorbs the impact, thereby providing dual absorption of the energy generated by the collision with the obstacle.

### SUMMARY

The technique described in JP 2022-70848 A employs a configuration in which, when the vehicle collides with an obstacle, the vehicle body rides over the obstacle while mitigating the impact. Therefore, there is a possibility that the impact may propagate to the battery when the vehicle body rides over the obstacle.

The present disclosure has been made in view of the above circumstances, and an object thereof is to provide a vehicle battery protection device that can reduce the possibility of contact between an obstacle and the battery.

A vehicle battery protection device according to a first aspect includes: a flap provided at a lower portion of a vehicle body of a vehicle in which a battery is disposed below a floor of the vehicle body, the flap being movable between a deployed position in which the flap protrudes from a lower surface of the vehicle body, and a retracted position in which the flap is retracted upward from the deployed position; a detection unit configured to detect an obstacle located in a direction of travel of the vehicle; and a control unit configured to move the flap to the deployed position when determination is made that there is a possibility that the obstacle detected by the detection unit comes into contact with the battery.

In the first aspect, the flap is provided at the lower portion of the vehicle body, and the flap is movable between the deployed position in which the flap protrudes from the lower surface of the vehicle body, and the retracted position in which the flap is retracted upward from the deployed position. When it is determined that there is a possibility that the obstacle located in the direction of travel of the vehicle comes into contact with the battery disposed below the floor of the vehicle body, the flap is moved to the deployed position. In this manner, the flap can block the obstacle from entering beneath the floor of the vehicle body, thereby reducing the possibility of contact between the obstacle and the battery.

According to a second aspect, in the first aspect, the flap is provided at any one of the following positions: a front end of a front bumper, a front end of a front suspension, a rear end of the front suspension, a rear end of a rear bumper, a rear end of a rear suspension, and a front end of the rear suspension.

In the second aspect, when the flap is provided at the front end of the front bumper, the front end of the front suspension, or the rear end of the front suspension, the flap can block an obstacle approaching the vehicle from the front from entering beneath the floor of the vehicle body. In addition, when the flap is provided at the rear end of the rear bumper, the rear end of the rear suspension, or the front end of the rear suspension, the flap can block an obstacle approaching the vehicle from the rear from entering beneath the floor of the vehicle body.

According to a third aspect, in the first aspect, the detection unit is configured to detect the height of the obstacle when the obstacle located in the direction of travel of the vehicle is detected, and the control unit is also configured to determine that there is a possibility that the obstacle comes into contact with the battery, when the height of the obstacle detected by the detection unit is greater than or equal to the minimum ground clearance of the vehicle body.

In the third aspect, the height of the obstacle is detected, and when the height of the obstacle is greater than or equal to the minimum ground clearance of the vehicle body, it is determined that there is a possibility that the obstacle comes into contact with the battery. It is therefore possible to accurately determine whether there is a possibility that the obstacle comes into contact with the battery.

According to a fourth aspect, in the first aspect, the control unit is configured to actuate a brake of the vehicle when determination is made that there is a possibility that the obstacle comes into contact with the battery, and to move the flap to the deployed position when determination is made, even after the brake is actuated, that contact between the obstacle and the battery is unavoidable.

In the fourth aspect, the brake of the vehicle is actuated when it is determined that there is a possibility that the obstacle comes into contact with the battery. when it is determined, even after the brake is actuated, that contact between the obstacle and the battery is unavoidable, such as when it is determined that the vehicle cannot be brought to a stop before reaching the obstacle because the original vehicle speed is high or for other reasons, the flap is moved to the deployed position. Accordingly, when contact between the obstacle and the battery is avoidable through braking, the flap is not moved to the deployed position. As a result, the number of times the flap is moved to the deployed position is reduced, thereby achieving an extended service life of the flap, an actuator configured to move the flap, and the like.

The present disclosure can reduce the possibility of contact between an obstacle and a battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a battery protection device according to an embodiment;

FIG. 2 is a conceptual view illustrating an example of a vehicle and an obstacle;

FIG. 3A is a side view illustrating the vehicle with a flap in a retracted position;

FIG. 3B is a side view illustrating the vehicle with the flap in a deployed position;

FIG. 4 is a flowchart illustrating a flap control process;

FIG. 5A is a side view of the vehicle illustrating a variation of the flap installation position;

FIG. 5B is a side view of the vehicle illustrating another variation of the flap installation position; and

FIG. 5C is a side view of the vehicle illustrating still another variation of the flap installation position.

### DETAILED DESCRIPTION OF EMBODIMENTS

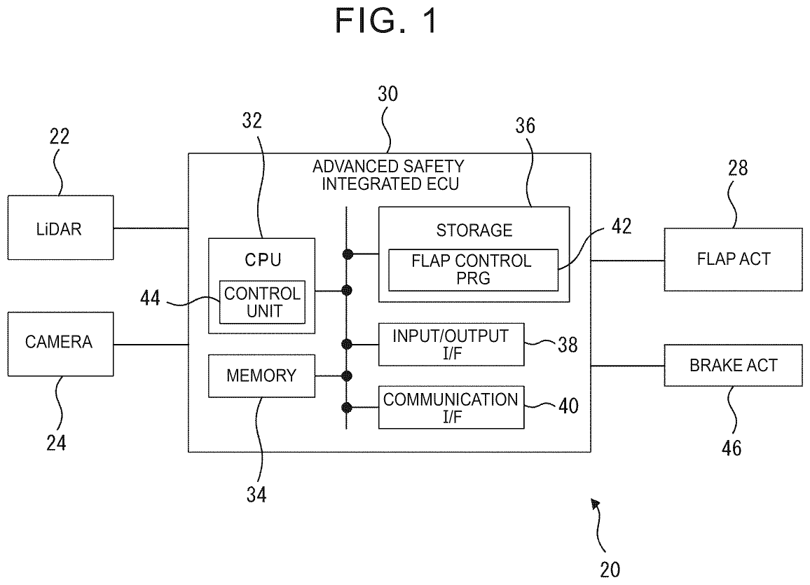

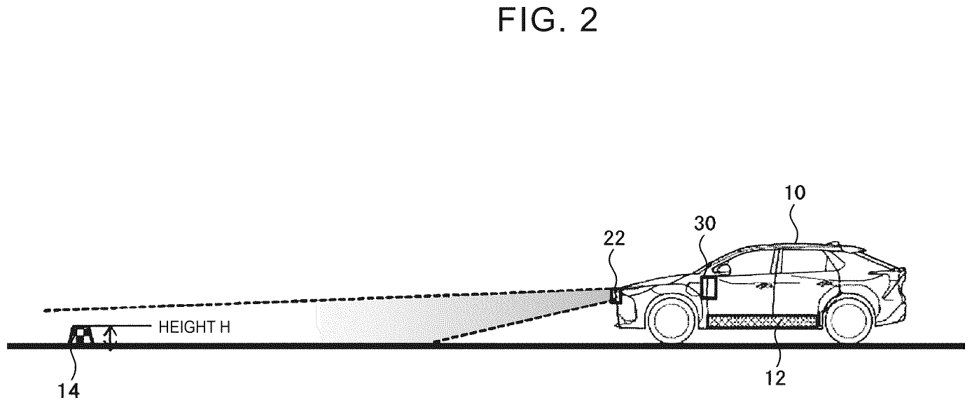

Hereinafter, an example of an embodiment of the present disclosure will be described in detail with reference to the drawings. FIG. 1 shows a battery protection device 20 according to the present embodiment. As shown in FIG. 2, a vehicle 10 equipped with the battery protection device 20 includes a battery 12 disposed under the floor of the vehicle body. The battery 12 serves as a driving source for a motor generator (MG) (not shown). The vehicle 10 may be a plug-in hybrid electric vehicle (PHEV), a battery electric vehicle (BEV), or a hybrid electric vehicle (HEV).

The battery protection device 20 is configured to reduce the possibility of contact between the battery 12 and an obstacle 14, and includes a Light Detection and Ranging (LiDAR) 22 and a camera 24. The LiDAR 22 is provided at a front end of the vehicle 10, and emits a laser beam forward the area ahead of the vehicle 10. Based on information on the reflected light, the LiDAR 22 detects the distance to, and height H (see FIG. 2) of, an obstacle 14 located in front of the vehicle 10.

The camera 24 is configured as a stereo camera and is provided, for example, inside the cabin of the vehicle 10. The camera 24 captures images in front of the vehicle 10 and detects the distance to, and height H of, the obstacle 14 located in front of the vehicle 10, based on the parallax between the captured right and left images. The LiDAR 22 and the camera 24 are connected to an advanced safety integrated electronic control unit (ECU) 30, and output the detection results regarding the obstacle 14 to the ECU 30. The LiDAR 22 and the camera 24 are examples of a detection unit according to the present disclosure.

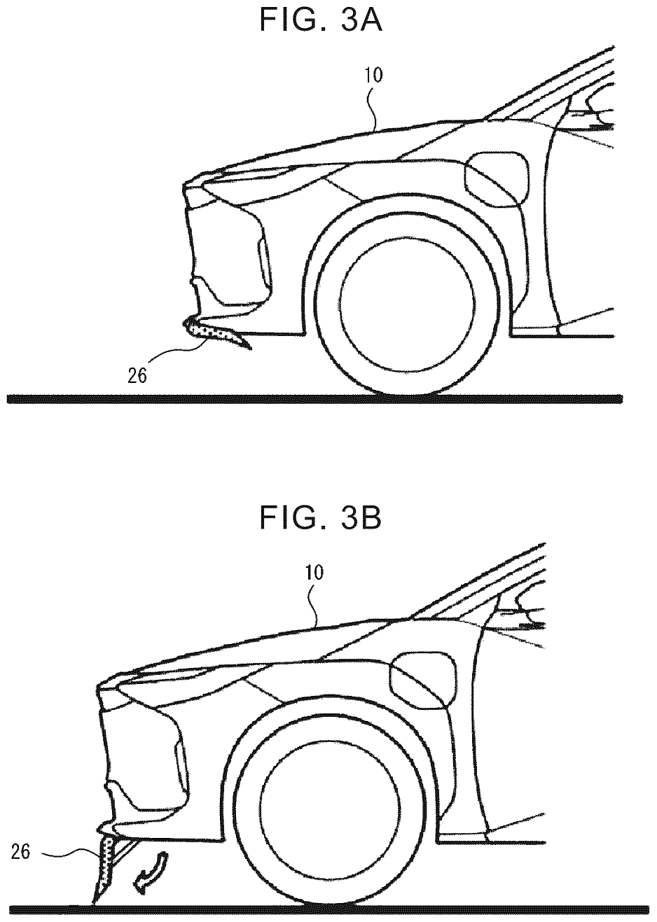

As shown in FIGS. 3A and 3B, a flap 26 is provided at a lower part of a front end of a front bumper of the vehicle 10. The flap 26 is movable between a deployed position (shown in FIG. 3B) in which it protrudes from the lower surface of the vehicle body, and a retracted position (shown in FIG. 3A) in which it is retracted upward from the deployed position. The flap 26 is made of, for example, rubber or a material having similar flexibility. The flap 26 is moved to the deployed position or the retracted position by a flap actuator (flap ACT) 28 (see FIG. 1). The flap ACT 28 is connected to the advanced safety integrated ECU 30, and the operation of the flap ACT 28 is controlled by the ECU 30.

The advanced safety integrated ECU 30 includes a central processing unit (CPU) 32, a memory 34 such as a read-only memory (ROM) and a random access memory (RAM), a storage 36 such as a hard disk drive (HDD) or a solid state drive (SSD), an input/output interface (I/F) 38, and a communication interface (I/F) 40. A brake actuator (brake ACT) 46 capable of generating braking force in a brake device of the vehicle is connected to the advanced safety integrated ECU 30.

A flap control program 42 is stored in the storage 36. The advanced safety integrated ECU 30 serves as a control unit 44 by reading the flap control program 42 from the storage 36, loading it into the memory 34, and executing it by the CPU 32. When the control unit 44 determines that there is a possibility that the obstacle 14 detected by the LiDAR 22 or the camera 24 may come into contact with the battery 12, the control unit 44 moves the flap 26 to the deployed position by the flap ACT 28.

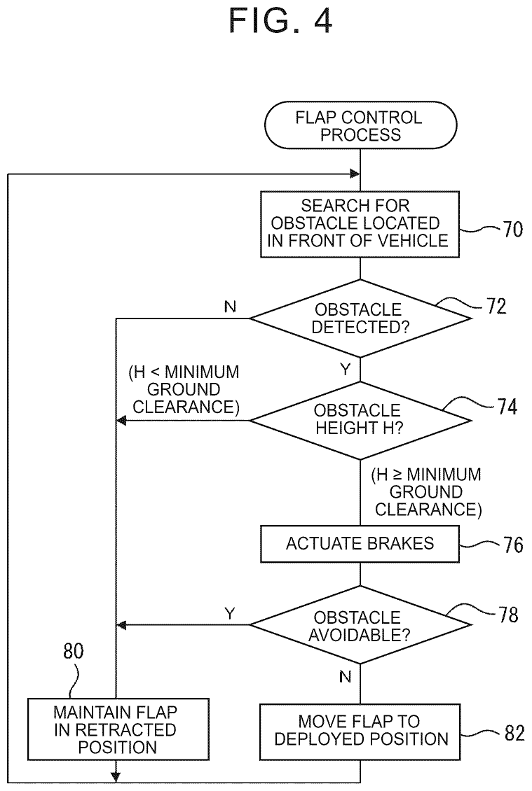

Next, as an operation of the present embodiment, a flap control process executed by the advanced safety integrated ECU 30 (control unit 44) while the ignition switch of the vehicle 10 is on will be described with reference to FIG. 4.

In step 70 of the flap control process, the control unit 44 causes the LiDAR 22 or the camera 24 to search for an obstacle 14 located in front of the vehicle 10. In step 72, the control unit 44 determines whether an obstacle 14 located in front of the vehicle 10 has been detected by the LiDAR 22 or the camera 24.

When the determination is negative in step 72, the process proceeds to step 80. In step 80, the control unit 44 maintains the flap 26 in the retracted position, and the process returns to step 70. In this manner, while there is no obstacle 14 in front of the vehicle 10, the flap 26 remains in the retracted position. Therefore, the aerodynamic performance of the vehicle 10 is less likely to deteriorate.

When the determination in step 72 is affirmative, the process proceeds to step 74. In step 74, the control unit 44 acquires the height H of the obstacle 14 located in front of the vehicle 10 from the LiDAR 22 or the camera 24, and compares the height H of the obstacle 14 with the minimum ground clearance of the vehicle 10.

When the height H of the obstacle 14 is smaller than the minimum ground clearance of the vehicle 10, it can be determined that the obstacle 14 is unlikely to come into contact with the battery 12. Accordingly, when the height H of the obstacle 14 is smaller than the minimum ground clearance of the vehicle 10, the process proceeds from step 74 to step 80. In step 80, the control unit 44 maintains the flap 26 in the retracted position as described above.

On the other hand, when the height H of the obstacle 14 is greater than or equal to the minimum ground clearance of the vehicle 10, it can be determined that there is a possibility that the obstacle 14 may come into contact with the battery 12. Accordingly, when the height H of the obstacle 14 is greater than or equal to the minimum ground clearance of the vehicle 10, the process proceeds from step 74 to step 76. In step 76, the control unit 44 actuates the brakes of the vehicle 10 by the brake ACT 46 to decelerate the vehicle 10. This increases the possibility of avoiding a collision with the obstacle 14 by bringing the vehicle 10 to a stop before reaching the obstacle through braking, particularly when the original vehicle speed is low.

In the subsequent step 78, the control unit 44 determines whether a collision with the obstacle 14 is avoidable. When the determination in step 78 is affirmative, the process proceeds to step 80. In step 80, the control unit 44 maintains the flap 26 in the retracted position as described above.

When the determination in step 78 is negative, the process proceeds to step 82. In step 82, the control unit 44 moves the flap 26 to the deployed position by the flap ACT 28. As a result, when the obstacle 14 collides with the flap 26, the flap 26 blocks the obstacle 14 from entering beneath the floor of the vehicle body, thereby reducing the possibility of contact between the obstacle 14 and the battery 12.

As described above, in the present embodiment, the battery protection device 20 includes the flap 26 that is provided at a lower portion of the vehicle body of the vehicle 10 in which the battery 12 is disposed below the floor of the vehicle body. The flap 26 is movable between the deployed position in which it protrudes from the lower surface of the vehicle body and the retracted position in which it is retracted upward from the deployed position. The LiDAR 22 or the camera 24 detects an obstacle 14 located in the direction of travel of the vehicle 10. When the control unit 44 determines that there is a possibility that the obstacle 14 detected by the LiDAR 22 or the camera 24 may come into contact with the battery 12, the control unit 44 moves the flap 26 to the deployed position. In this manner, the flap 26 blocks the obstacle 14 from entering beneath the floor of the vehicle body, thereby reducing the possibility of contact between the obstacle 14 and the battery 12. Since the flap 26 reduces the possibility of contact between the obstacle 14 and the battery 12, a protective member (such as a shear panel) for protecting the battery 12 can be omitted from the area beneath the floor of the vehicle body, thereby reducing the weight of the vehicle 10 and the number of components.

In the present embodiment, the flap 26 is provided at the front end of the front bumper of the vehicle 10. Accordingly, it is possible to block the obstacle 14 approaching the vehicle 10 from the front from entering beneath the floor of the vehicle body.

In the present embodiment, when the LiDAR 22 or the camera 24 detects an obstacle 14 in the direction of travel of the vehicle 10, it detects the height H of the obstacle 14. When the height H of the obstacle 14 detected by the LiDAR 22 or the camera 24 is greater than or equal to the minimum ground clearance of the vehicle body, the control unit 44 determines that there is a possibility that the obstacle 14 may come into contact with the battery 12. It is therefore possible to accurately determine whether there is a possibility that the obstacle 14 may come into contact with the battery 12.

In the present embodiment, when the control unit 44 determines that there is a possibility that the obstacle 14 may come into contact with the battery 12, the control unit 44 actuates the brake system of the vehicle 10. When it is determined, even after the actuation of the brake system, that contact between the obstacle 14 and the battery 12 is not avoidable, the control unit 44 moves the flap 26 to the deployed position. Accordingly, when contact between the obstacle 14 and the battery 12 is avoidable through braking, the flap 26 is not moved to the deployed position. As a result, the number of times the flap 26 is moved to the deployed position is reduced, thereby achieving an extended service life of the flap 26, the flap ACT 28, and the like.

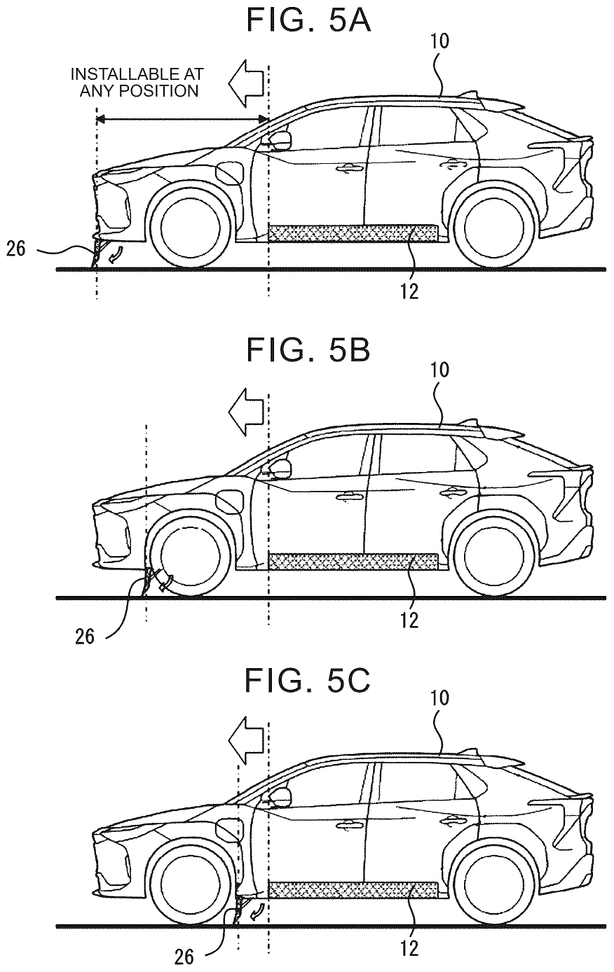

The embodiment described above illustrates an example in which the flap 26 is provided at the front end of the front bumper of the vehicle 10. However, in the present disclosure, the installation position of the flap 26 is not limited to this example. As shown in FIG. 5A, the flap 26 may be provided at any position within the range from the front end of the front bumper to the front end of the battery 12. For example, as shown in FIG. 5B, the flap 26 may be provided at a position corresponding to the front end of the front suspension, or as shown in FIG. 5C, the flap 26 may be provided at a position corresponding to the rear end of the front suspension.

In the above embodiment, the direction of travel of the vehicle 10 has been described as the forward direction. However, the direction of travel of the vehicle 10 may be the reverse direction. In order to reduce the possibility of contact between the obstacle 14 and the battery 12 when the vehicle 10 is reversing, the flap 26 may be provided at a position for reverse travel, that is, at any position within the range from the rear end of the rear bumper to the rear end of the battery 12. For example, the flap 26 may be provided at the rear end of the rear bumper, at a position corresponding to the rear end of the rear suspension, or at a position corresponding to the front end of the rear suspension. When the vehicle 10 is reversing and an obstacle 14 is detected in the reverse traveling direction of the vehicle 10 by the detection unit, and it is determined that there is a possibility that the detected obstacle 14 may come into contact with the battery 12, the flap 26 for reverse travel is moved to the deployed position. In this manner, even when the vehicle 10 is reversing, the flap 26 blocks the obstacle 14 from entering beneath the floor of the vehicle body, thereby reducing the possibility of contact between the obstacle 14 and the battery 12.

The above embodiment illustrates an example in which the flap control program 42 is stored (installed) in advance in the storage 36. However, the flap control program 42 may be provided in the form recorded on a non-transitory recording medium such as a hard disk drive (HDD), a solid-state drive (SSD), or a digital versatile disc (DVD).

What is claimed is:

1. A vehicle battery protection device comprising:
a flap provided at a lower portion of a vehicle body of a vehicle in which a battery is disposed below a floor of the vehicle body, the flap being movable between a deployed position in which the flap protrudes from a lower surface of the vehicle body, and a retracted position in which the flap is retracted upward from the deployed position;
a detection unit configured to detect an obstacle located in a direction of travel of the vehicle; and
a control unit configured to move the flap to the deployed position when determination is made that there is a possibility that the obstacle detected by the detection unit comes into contact with the battery.

2. The vehicle battery protection device according to claim 1, wherein the flap is provided at any one of the following positions: a front end of a front bumper, a front end of a front suspension, a rear end of the front suspension, a rear end of a rear bumper, a rear end of a rear suspension, and a front end of the rear suspension.

3. The vehicle battery protection device according to claim 1, wherein:
the detection unit is configured to detect a height of the obstacle when the obstacle located in the direction of travel of the vehicle is detected; and
the control unit is configured to determine that there is a possibility that the obstacle comes into contact with the battery, when the height of the obstacle detected by the detection unit is greater than or equal to a minimum ground clearance of the vehicle body.

4. The vehicle battery protection device according to claim 1, wherein the control unit is configured to actuate a brake of the vehicle when determination is made that there is a possibility that the obstacle comes into contact with the battery, and to move the flap to the deployed position when determination is made, even after the brake is actuated, that contact between the obstacle and the battery is unavoidable.
